(19) United States
(12) Patent Application Publication
(10) Pub. No.: US 2007/0210906 A1
(43) Pub. Date: Sep. 13, 2007

(54) Signaling Device For Displaying Warning And/Or Informational Alerts In Vehicles

(76) Inventors: Peter Knoll, Ettlingen (DE); Hannelore Koehl, Sindelfingen (DE); Marc Arnon, Leonberg (DE)

Correspondence Address: KENYON & KENYON LLP, ONE BROADWAY, NEW YORK, NY, 10004, US

(21) Appl. No.: 11/547,771

(22) PCT Filed: Feb. 25, 2005
(86) PCT No.: PCT/EP05/50813

§ 371 Date: Oct. 4, 2006

(30) Foreign Application Priority Data
Apr. 6, 2004 (DE) 10 2004 016 808.3

(51) Int. Cl. B60Q 1/00

(52) U.S. Cl. 340/461; 340/436; 340/438

(57) ABSTRACT

A signaling device for displaying and/or issuing warning and/or informational alerts in vehicles via visual and/or acoustic signal sources is described, direction-related information being supplied to the driver based on an available signal, e.g., from a collision avoidance system, and this information relates to an event associated with a specific object regarding which the warning is to be issued.

### FIELD OF THE INVENTION

The present invention relates to a signaling device for displaying warning and/or informational alerts in vehicles.

### BACKGROUND INFORMATION

In order to improve vehicle safety, information important to the driver may be displayed on the windshield directly in his field of vision, so that he no longer has to avert his gaze from the traffic if he wishes to acquire this information. Moreover, an electroluminescent display (ELD), which is situated in the vehicle windshield in the lower part of the field of vision above the steering wheel as a matrix-shaped structure, is discussed in German patent document no. 41 27 656. Specific individual points of the matrix may be rendered visible to provide a warning and/or an informational alert.

Furthermore, collision avoidance systems, which survey the area surrounding the vehicle for objects which could potentially cause a collision, are known. When such an object is detected, these collision avoidance systems supply a signal which may be analyzed and sent to the driver visually or acoustically. The visual display may be implemented for example using an ELD discussed in German patent document no. 41 27 656.

Another visual display is discussed in German patent document no. 101 47 271, which describes a vehicle turn signal system in which a reflection arrangement is provided in a vehicle windshield at the left and right outer edge, which reflect outward a light beam radiated into the vehicle windshield, thus providing a turn signal function displayed to drivers of other vehicles. Silver strips or silver pigments as the reflective material are disclosed, which thanks to their small geometric structures at the edge of the windshield only slightly impair the view through the windshield, but nonetheless do place constraints on the field of vision.

Moreover, the issuing of an acoustic warning and/or informational alert for vehicles is known, distance sensors being situated in the bumpers, which generate a signal for an acoustic alert to warn the driver when the distance in question falls below a specified value.

### SUMMARY OF THE INVENTION

An object of the exemplary embodiments and/or exemplary methods of the present invention is to improve safety and/or ease of use of a vehicle.

This object may be achieved via the features as set forth and described herein. Advantageous and useful further refinements of the exemplary embodiments and/or exemplary methods of the present invention are also set forth and described herein.

The exemplary embodiments and/or exemplary methods of the present invention is directed to a signaling device for displaying warning and/or informational alerts in vehicles, having at least one visual display element located within the visible area of a windshield and situated thereon. An aspect of the exemplary embodiments and/or exemplary methods of the present invention is that a plurality of display elements are situated in a significant area of the windshield, in particular on or in the windshield, and may be selectively rendered visible to display a warning and/or an informational alert.

The significant part of the windshield refers in particular to the significant part of the width of the windshield which arises from the field of vision relevant for the task of driving. Information must be displayable to the driver in such a way that it is distributed across the windshield from the left to the right edge as necessary. Accordingly, the significant part of the windshield may also extend across a significant part of the height of the windshield, all or almost all of the windshield thus being usable as a display surface.

The advantage of such distribution of display elements is that by activating a specific display element the driver may be informed in a contact-analogous manner regarding the direction from which he should expect the object affecting traffic to come. This is accomplished by rendering visible the display element which lies directly in the line of vision between the driver's eye/head and an object detected by the device surveying the area surrounding the vehicle. Thanks to the display element being rendered visible, the driver automatically looks in the direction of the object. If the object is not yet in the driver's theoretical field of vision, display elements in the area at the edge of the windshield may be activated to show the direction from which the object should be expected to come.

In one embodiment, the display elements may already be located in the structure in which they provide the driver with a signal or alert when rendered visible.

Thus they may be activated via a simple arrangement. To accomplish this, all that is required is to generate a single signal to render visible a display element having the assigned arrangement for ensuring visibility to the driver.

However, the display elements may also have more complex structures. For example, each may be designed as a separate matrix. They may also be designed as a multi-component structure having a plurality of identical or different display symbols which are situated at the same display point and have different sizes overlying one another or if necessary surrounding one another. Thus it is feasible to vary the display symbol with regard to its shape and/or size, so that it is more noticeable or conveys more information.

The alert may be continuous or flashing, with a constant or varying frequency. Furthermore, a plurality of display elements may be rendered visible simultaneously or sequentially, in particular as a function of the information to be conveyed.

Another important aspect of the exemplary embodiments and/or exemplary methods of the present invention is that a channel-shaped optical waveguide is assigned to at least one display element as the light supply, in particular an optical waveguide having sidewalls in the direction of the channel to laterally delimit the light supply with regard to the surface of the windshield.

The light supplied to render the display element visible remains within the optical waveguide and is thus only able to enter and exit at its front surfaces, thus enabling more than one display element to be selectively supplied independently of one another.

Designing the optical waveguide as an optical waveguide separate from the windshield, if necessary as a fiber-optic waveguide, constitutes one possible embodiment. Thus there is broad design flexibility with regard to the light supply, which if necessary may involve crisscrossed or bundled optical waveguides.

In a further embodiment, the optical waveguide(s) may be provided as a structure in a film or pane of glass, e.g., as a structured film or pane or as a structured layer therein.

If a plurality of optical waveguides is assigned to each display element, this makes further options for the signaling of alerts feasible. For example, the display elements may be activated using a variety of light sources, it being possible for a single type of display element to convey various different kinds of information.

According to an exemplary embodiment of the present invention, the display elements are designed as structures which are invisible when in the deactivated state. This has the advantage for example over the turn signal embodiment having the silver strips that the structures in the pane do not distract the driver when they are in the inactive state.

Providing a light source makes it possible to supply the display elements with light to render them visible. It is also feasible for a plurality of light sources to be made available to supply the display elements, so that the display elements may be rendered visible individually, in groups using a single color, or using more than one color.

The display elements may also be designed as holograms. Thus it is for example feasible for the display elements to be rendered visible using laser light only. This keeps unfavorable radiation from other light sources from accidentally activating the display elements and thereby irritating the driver with false alerts.

According to another exemplary embodiment, the display elements may be designed as actively light-emitting elements. If appropriate, there is no need for a light supply, and power may be supplied to the display elements via a simple electrical wire to render them visible. Basically a combination of the aforementioned embodiments is also feasible.

According to another exemplary embodiment, the display elements may be designed as a transparent organic light-emitting device (TOLED). These organic displays are transparent when in the deactivated state, i.e., when no current is applied, and do not emit the light required to display the warning and/or informational alert until an electrical current is applied. According to another possible embodiment, the display elements are designed as an ELD (electro-luminescent display). The signaling device is designed as an EL film, which is for example provided on the inner side of the vehicle windshield as a simple but effective embodiment. Both instances of these active self-illuminating display elements have the aforementioned advantage with regard to light supply.

The structures may also be designed in such a way that they have a filter effect for specific wavelengths. By providing an appropriate number of structures in the windshield, it is thus feasible to protect the vehicle interior against thermal radiation and the like.

According to another exemplary embodiment, the rendering visible of a warning and/or an informational alert is coupled with the issuing of an acoustic warning and/or informational alert.

Coupling of this kind has the advantage that the driver is also warned if he is not actually looking at the windshield, but rather has been distracted from the traffic by some event.

According to a third exemplary embodiment, a signaling device for displaying warning and/or informational alerts in vehicles which includes an acoustic signal source is provided and is characterized by the fact that a warning and/or informational alert is issued via the signal source in such a way that the alert contains information regarding the direction associated with an object detected using the detection arrangement for surveying the area surrounding the vehicle, regarding which the warning is being issued via the acoustic warning and/or informational alert.

Here, just as in the case of the visual signaling devices, the additional information contained in the directional alert greatly improves the ease of use of the vehicle, as the driver's attention is immediately guided in the direction in which a traffic event, potentially affected by an object, may be expected.

Another exemplary embodiment may be implemented in such a way that the information regarding the direction of the event to which the driver is being alerted is conveyed by selectively issuing an acoustic signal from one or more signal sources spatially distributed in the vehicle. For example, to accomplish this an acoustic signal may be issued at a location in the vehicle corresponding to the direction in which the detected object lies, for example to the right at the front.

According to a variation of this embodiment, the information regarding the direction in which the object has been detected is provided via a voice message from a signal source. It is also advantageously feasible to combine this with the previous embodiment. To accomplish this, as before, the voice message regarding the direction of the detected object is issued from a specific location in the vehicle, to guide the driver's attention toward the detected object. This ensures that a spatial signal effect is feasible, and the driver intuitively directs his attention in the corresponding direction.

Such a signal source may advantageously be a loudspeaker of a radio and/or music system customarily provided in a vehicle.

Another exemplary embodiment may be implemented in such a way that the warning and/or informational alert contains distance information regarding the event to which the driver is being alerted. Thus it is feasible to inform the driver whether the traffic event, potentially affected by the detected object, is immediately imminent, or whether a specified time will elapse before it occurs.

To accomplish this, it is conceivable that there are also different categories of distance information, e.g., ‘very close,’ ‘close,’ or ‘sufficiently distant.’ Signaling of this kind may for example be indicated by the frequency, the frequency becoming advantageously higher as the event approaches, so that the driver intuitively determines whether he should expect the object immediately or not until later.

### BRIEF DESCRIPTION OF THE DRAWINGS

FIG. 1 shows a schematic representation of a signaling device for displaying warning and/or informational alerts in vehicles, having display elements distributed across a windshield and situated therein, this being shown in a top view, and an enlarged view of part of the display element, this being shown in a sectional side view.

FIG. 2 shows a schematic representation of a signaling effect upon a driver by a signaling device.

FIG. 3 shows a schematic representation of signaling devices, the embodiment being a variant of that shown in FIG. 1.

FIG. 4 shows a schematic representation of signaling devices, the embodiment being another variant of that shown in FIG. 1.

FIG. 5 shows a schematic representation of signaling devices, the embodiment being another variant of that shown in FIG. 1.

FIG. 6 shows a schematic representation of a signaling device for combined issuing of a visual and an acoustic warning and/or informational alert.

### DETAILED DESCRIPTION

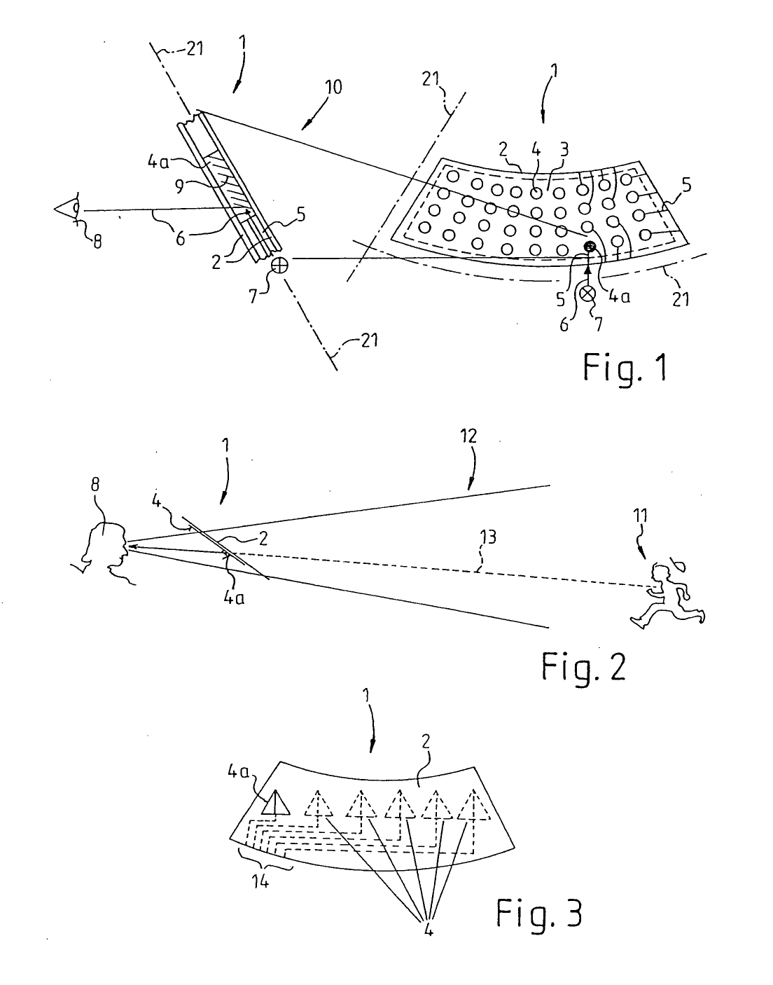

FIG. 1 schematically shows a signaling device 1 having a windshield 2 and display elements 4 distributed across it, this being shown in a top view, and an enlarged detailed section 10 of a display element 4a situated in windshield 2, this being shown in a sectional side view.

The right-hand part of FIG. 1 shows the top view of windshield 2 in which display elements 4 are situated and distributed across a significant part 3. Only display element 4a is active. To accomplish this, starting from light source 7 a light beam 6 is conveyed via an optical waveguide 5 to display element 4, which becomes visible to the driver when illuminated by the light beam. The other display elements 4 are not visible to the driver.

To accomplish this, structures 9 in display element 4 are so small that they are invisible to the human eye when in the non-illuminated state.

The same applies to optical waveguides 5. Moreover, they are also invisible to the driver when they are conveying the light beam, thanks to their ability to keep the light contained.

Detailed section 10 covers the area from visible display element 4a as far as the left-hand area shown in FIG. 1. The detailed section showing display element 4a, which is visible to driver 8, shows the path of light beam 6, which is generated by light source 7 and conveyed by optical waveguide 5 to display element 4a and reflected by this in the direction of the driver by structure 9.

In this case, windshield 2 is designed as a dual-component laminated glass pane, between the two components 2, 2 of which display elements 4 and optical waveguides 5 are situated. The proportions in the drawing are not to scale, as this is only an example. Such a system is possible but not necessarily required. It is also feasible for the signaling device to be situated on the outside of the pane. It is advantageously situated on the side of the pane facing the vehicle interior, so as to be protected against outside influences.

Plane 21 of windshield 2, which is significant for optical waveguides 5, is indicated in FIG. 1 by dash-dot lines.

FIG. 2 shows a schematic representation of a signaling effect upon a driver with a display element 4 that has been rendered visible. To accomplish this, the attention is directed to an object 11 in the line of vision of driver 8 behind display element 4a, which has been rendered visible, the object still being at a distance from the vehicle and displayed as the cause of an event that may potentially affect traffic

In this instance, a plurality of display elements 4 are situated on windshield 2 and distributed across its significant part 3. They are located on the surface of the pane facing the vehicle interior. Line of vision 13 of driver 8 in the direction of object 11 lies within the driver's normal vertical and horizontal field of vision 12 under normal traffic conditions. When display element 4a is rendered visible, as one of a plurality of otherwise invisible display elements 4, the driver's attention is guided in the direction from which object 11 is approaching.

The representations shown in FIGS. 3 through 5 also show display elements 4, 4a which are distributed across significant part 3 of windshield 3 [sic; 2] and in certain instances have different but geometrically predefined shapes. Another difference with regard to these representations is in the embodiment of the individual elements. In FIG. 3, display elements 4 are designed as TOLEDs. Only left-hand element 4a is visible, as electrical current has been applied. All other elements and supply conductors 14, which are shown as broken lines, are structures invisible to the human eye. In this representation display elements 4 and, respectively, 4a are shown as a warning triangle. Naturally other embodiments are also feasible.

FIG. 4 shows an embodiment which includes an electroluminescent film. In this case, display element 4a is rendered visible by activating the electroluminescent properties of display element 4, which is otherwise invisible. In this representation also, supply conductors 14 and invisible display elements 4 are shown using broken lines.

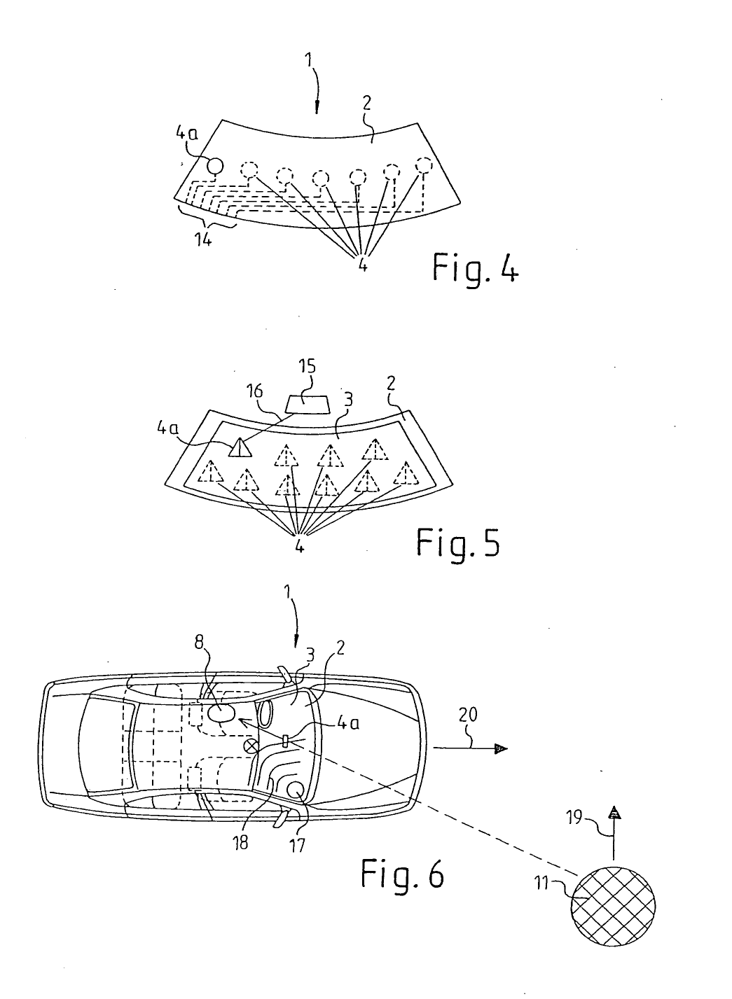

FIG. 5 also shows display elements 4, 4a, which are distributed across a significant part 3 of windshield 2 and in this case are designed as holograms. Using a laser beam 16 generated by a laser 15, these holograms, which are invisible under normal light conditions, are illuminated using a wavelength appropriate to the hologram and are thus rendered visible to the driver. Display elements 4 may be diffusely reflective holograms, so that even if the angle for illuminating display element 4 with laser beam 16 is not optimal they are still activated by laser beam 16.

FIG. 6 shows an embodiment of a signaling device in which a visual as well as an acoustic warning for the driver is generated. In the top view of the vehicle, display element 4a is rendered visible in the middle of windshield 2, i.e., at the right front from the viewpoint of driver 8. This directs the driver's attention to an object 11, which is located to the right of the vehicle, in this case a direction of movement 19 toward the area ahead of the vehicle being assumed, the vehicle itself moving in direction of movement 20.

In addition to a visual warning and/or an informational alert, an acoustic signal 18 is issued from an acoustic signal source 17, in this case a loudspeaker of the vehicle's music or radio system, at the right front of the vehicle. This guides the driver's attention in the direction of object 11, visually and acoustically.

1-15. (canceled)

16. A signaling device for displaying at least one of warning and an informational alert in vehicles, comprising:
visual display elements located within a visible area of a windshield,
wherein a plurality of the visual display elements are distributed across a significant part of the windshield, and are selectively renderable to be visible to display at least one of the warning and an informational alert.

17. The signaling device of claim 16, wherein a channel-shaped optical waveguide is assigned to the visual display elements to supply light.

18. The signaling device of claim 17, wherein the optical waveguide is provided as a separate optical waveguide at least one of on and in the windshield.

19. The signaling device of claim 17, wherein the optical waveguide is provided via a structuring of the windshield.

20. The signaling device of claim 16, wherein at least one of the visual display elements is arranged as a structure which is invisible when in a deactivated state.

21. The signaling device of claim 16, wherein a light source supplies light to at least one of the visual display elements to render it visible.

22. The signaling device of claim 16, wherein at least one of the visual display elements includes a hologram.

23. The signaling device of claim 16, wherein at least one of the visual display elements includes an activatable light-emitting element.

24. The signaling device of claim 16, wherein at least one of the visual display elements includes a transparent organic light-emitting device (TOLED).

25. The signaling device of claim 16, wherein at least one of the visual display elements includes an electroluminescent display (ELD).

26. The signaling device of claim 16, wherein rendering of the at least one of the warning and the informational alert is coupled with at least another of acoustic warning and informational alert.

27. A signaling device for issuing at least one of a warning and an informational alert in a vehicle having at least one acoustic signal source, comprising:
an alerting arrangement for providing the at least one of the warning and the informational alert via the signal source so that the alerting contains information regarding a direction associated with an object detected using a detection arrangement for surveying an area surrounding the vehicle, regarding which the alerting arrangement provides the at least one of the warning and the information alert.

28. The signaling device of claim 27, wherein the information regarding the direction in which the object lies is provided by selectively issuing an acoustic signal from at least one of a plurality of signal sources spatially distributed in the vehicle.

29. The signaling device of claim 27, wherein the information regarding the direction in which the object lies is provided by issuing a voice message from the at least one signal source.

30. The signaling device of claim 27, wherein the at least one of the warning and the informational alert contains distance information regarding the object regarding which the warning is provided.
